(19) United States
(12) Patent Application Publication
(10) Pub. No.: US 2006/0231357 A1
(43) Pub. Date: Oct. 19, 2006

(54) Field responsive shear thickening fluid

(76) Inventors: Mark R. Jolly, Raleigh, NC (US); Jonathan W. Bender, Cary, NC (US)

Correspondence Address: LORD CORPORATION;PATENT & LEGAL SERVICES, 111 LORD DRIVE, CARY, NC, 27512, US

(21) Appl. No.: 11/451,854

(22) Filed: Jun. 13, 2006

Related U.S. Application Data
(62) Division of application No. 10/138,286, filed on May 3, 2002.
(60) Provisional application No. 60/288,715, filed on May 4, 2001.

(51) Int. Cl. F16F 9/53

(52) U.S. Cl. 188/267.1

(57) ABSTRACT

An active controllable, shear thickening, field responsive device is disclosed and contains a fluid including a carrier component and at least about 40 percent by volume, based on the total volume of the fluid, of a particle component. The fluid can comprise either a field responsive dispersed particle component or a field responsive carrier. The field responsive dispersed phase fluid comprises magnetic- or electrical-responsive particles having a specified average particle size. When subjected to a predetermined shear rate and, optionally, a predetermined magnetic or electrical field, the shear thickening composition undergoes a dramatic and substantial increase in viscosity and shear stress over a very short time period.

This application claims benefit of U.S. Provisional Application No. 60/288,715, filed May 4, 2001.

### BACKGROUND OF THE INVENTION

This invention relates to controllable devices containing field-responsive fluids that exhibit discontinuous increases in flow resistance as controlled by changes in the applied magnetic or electrical fields.

Rheological fluids which are responsive to a magnetic field are known. Fluid compositions that undergo a change in viscosity in the presence of a magnetic field are commonly referred to as Bingham magnetic fluids or magnetorheological (MR) fluids. Magnetorheological fluids typically include magnetic-responsive particles dispersed or suspended in a carrier fluid. In the presence of a magnetic field, the magnetic-responsive particles become polarized and are thereby organized into chains of particles or particle fibrils within the carrier fluid. The chains of particles act to increase the viscosity or flow resistance of the overall materials resulting in the development of a solid mass having a yield stress that must be exceeded to induce onset of flow of the magnetorheological fluid. Examples, of solid magnetic particles which have been heretofore proposed for use in a magnetic field responsive fluid are magnetite and carbonyl iron. The fluid also may contain a surfactant to keep the solid particles in suspension in the vehicle.

Electroheological (ER) fluids responsive to an electric field are also known. Electrorheological fluids exhibit controllable flow resistance as with magnetorheological fluids but without as high yield stress as is associated with MR fluids. Typical electrorheological fluids include a carrier component, an electrical-responsive submicron sized particle component and, optionally, an activator. ER fluids are used in clutches, shock absorbers, and other devices. Electric field responsive fluids and magnetic field responsive fluids include a vehicle, for instance a dielectric medium, such as mineral oil or silicone oil, and solid particles. ER fluids are conventionally operated it flow velocities and shear rates in which continuous incremental changes in viscosity occur in response to the applied field.

Silica gel is frequently used in electroviscous fluids which are responsive to an electric field, as the solid which is field-responsive, and are suitable in the present invention. U.S. Pat. No. 3,385,793 discloses an electroviscous fluid which is conductive. The fluid includes 30%-55% silica gel and 25%-35% silicone oil which functions as a vehicle. The fluid can also contain 1%-40% iron particles disclosed to function as a conductive agent. Other U.S. patents disclosing the use of silica gels in electroviscous fluids are U.S. Pat. Nos. 3,047,507; 3,221,849; 3,250,726; 4,645,614; and 4,668,417, each of which are incorporated herein by reference.

U.S. Pat. No. 2,661,825 discloses both ferromagnetic fluids which are responsive to an electromagnetic field, and which contain carbonyl iron; and electroviscous fluids which are responsive to an electric field and which contain silica gel. In the electroviscous fluids, the silica gel is used as the field-responsive solid, not as a dispersant. The electroviscous fluids comprise dry ground silica gel, a surfacant, such as sorbitol sesquioleate, a vehicle such as kerosene, and other ingredients.

U.S. Pat. No. 2,661,596 discloses a composition which is responsive to both electric and magnetic fields. The composition comprises micronized powders of ferrites, which are mixed oxides of various metals. The composition also contains dispersants and thixotropic agents. The patent also discloses the use of silica gel powder in an electric field-responsive fluid, and the use of iron carbonyl in a magnetic field-responsive fluid. There is no suggestion of the use of silica gel in a magnetic field-responsive fluid.

A characteristic of the conventional uses with Theological fluids is that, when they are exposed to the appropriate energy field, solid particles in the fluid move into alignment and the ability of the fluid to flow is decreased. The rheological change is proportional to the field strength, and the shear or velocity imparted to the fluid is within the intrinsic shear or flow stability range for the fluid.

Field responsive fluids under shear or flow displacement forces exhibit characteristic critical shear stress Ycr. At the critical shear rate the fluid undergoes a discontinuous, i.e., rapid viscosity rise. See, Barnes, H. A. Shear-Thickening (“Dilatancy”) in Suspensions of Nonaggregated Solid Particles Dispersed in Newtonian Liquids; J. of Rheology 33 (2), John Wiley & Sons, Inc. 1989, pp. 329-366. This effect is conventionally utilized, for example in passive speed controlling devices, amplitude dependent damping, as well as in formulated jet fuels. See, Laun, H. M., et al, Rheology of Extremely Shear Thickening Polymer Dispersions (Passively Viscosity Switching Fluids), J. of Rheology, 35 (6), 1991, pp. 999-1032.

MR fluids are useful in devices or systems for controlling vibration and/or noise. Controllable forces act upon a piston in linear devices such as dampers, mounts and similar devices. Magnetorheological fluids are also useful for providing controllable torque acting upon a rotor in rotary devices. Linear or rotary devices include clutches, brakes, valves, dampers, mounts and similar devices.

U.S. Pat. No. 5,164,105 relates to an electroviscous fluid that includes a dispersion of silicone resin fine powder and a liquid phase consisting essentially of an electrically insulating oil. The dispersed phase is said to be present in an amount ranging from 1 to 60 percent by weight. The silicone resin fine powder is said to have a particle size of 0.05 to 100, preferably 1 to 20, μm.

U.S. Pat. No. 5,032,307 includes a general explanation of some of the features of conventional electrorheological fluids that suggests that particle volume percents above 50% should not be used and that the particle size is not critical for electrorheological fluids.

It would be of industrial importance to utilize low-cost, low permeablility materials, responsive to low field energies, especially for devices that employ relatively low field energy by active control of the critical shear stress by way of changes in the applied field.

### SUMMARY OF THE INVENTION

In one aspect, the invention provides a process for controlling motion by applying an electrical or magnetic field perpendicular to the shear or flow direction of a confined field-responsive fluid under shearing or displacement force, the fluid placed so as to be operative at the interface between a drive member and a driven member, and the motion of said driven member controlled by shifting the critical shear rate of said field-responsive fluid by a change in applied field strength.

In another aspect, the invention provides an active controllable device, utilizing a shear thickening, field responsive fluid comprising a carrier component and more than about 40 percent by volume, based on the total volume of the fluid, of a particle component. The preferred particles are magnetic- or electrical-responsive particles having an average particle size distribution across a range of from 100 nm to 3000 nm. When subjected to a predetermined shear rate and a predetermined magnetic or electrical field, the shear thickening composition undergoes a dramatic and substantial increase in viscosity and shear stress over a very short time period. The invention is embodied in devices and methods using solely magnetic and/or electrical field-responsive particles, mixtures of magnetic and/or electrical field responsive particles together with field non-responsive particles, as well as field-nonresponsive particles dispersed in a field-responsive carrier fluid.

In one embodiment, the present invention therefore provides a method for dramatically and substantially increasing over a very short period of time the viscosity and shear stress of a field responsive fluid that includes mixing magnetic- or electrical-responsive particles having an average particle size distribution of 300 nm to 800 nm with a carrier component so that the resulting field responsive fluid includes more than 40 percent by volume (vol %), preferably 50 vol % or more, based on the total volume of the fluid, of the particle component and then subjecting the resulting fluid to a shearing force at or near the critical shear rate, and applying a magnetic or electrical field to induce a change in the critical shear rate for the fluid, triggering or eliminating a discontinuous shear thickening response, depending on the mode of action desired for the device.

### BRIEF DESCRIPTION OF THE DRAWINGS

The preferred embodiments of the invention will be described in more detail below with reference to the following drawings:

FIG. 1 depicts crossectional schematic views of basic disc and drum brake devices according to the present invention.

FIG. 2 depicts crossectional sehematic views of basic disc and drum clutch devices according to the present invention.

FIG. 3 depicts crossectional sehematic views of a damper device according to the present invention.

FIG. 4 depicts a crossectional sehematic view of a electric field responsive clutch device according to the present invention.

FIG. 5 depicts a crossectional sehematic view of a electric field responsive damper device according to the present invention.

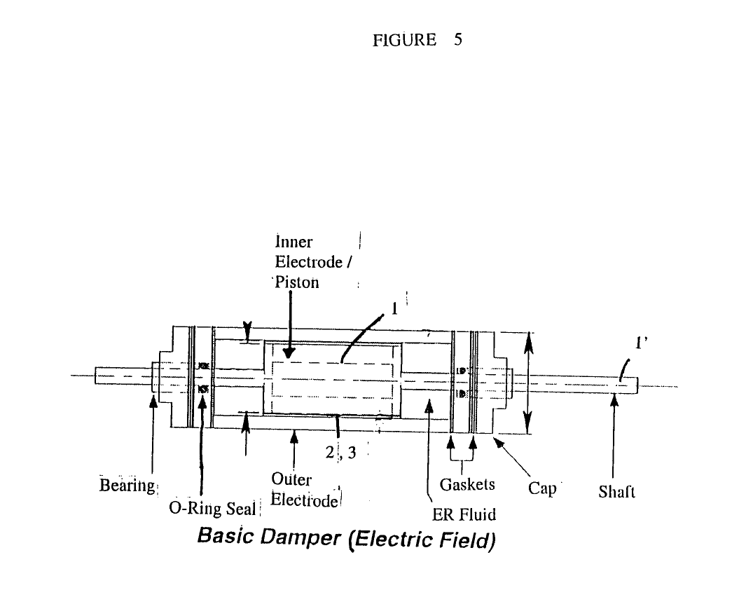

FIG. 6 is a graph plotting expected viscosity vs. shear rate for a fluid according to the invention that is subjected to a given magnetic (H) or electrical (E) field;

FIG. 7 is a graph plotting expected shear stress vs. shear rate for a fluid according to the invention that is subjected to a given magnetic (H) or electrical (E) field;

FIG. 8 is a graph plotting viscosity vs. shear rate for a conventional magnetorheological or electrorheological fluid that is subjected to a given magnetic (H) or electrical (E) field; and

FIG. 9 is a graph plotting shear stress vs. shear rate for a conventional magnetorheological or electrorheological fluid that is subjected to a given magnetic (H) or electrical (E) field.

FIG. 10 is a graphical plot of stress on the ordinate versus shear rate on the abscissa for a 66% silica dispersion in methylcyclohexanol subject to varied electrical field strength.

### DETAILED DESCRIPTION OF THE PREFERRED EMBODIMENTS

The fluid of the invention utilizes control of shear thickening characteristics of shear thickening fluids at or near their critical shear stress rates by the active change in applied magnetic or electrical fields. Shear thickening results when interparticle hydrodynamic forces generated by fluid flow overcome repulsive interparticle interactions to cluster together resulting in a rapid, sometimes discontinuous increase in viscosity over a narrow shear rate range. The narrow shear rate range at which a substantial or discontinuous change shear stress occurs is referred to herein as the “onset shear rate” or “critical shear rate.’

According to the invention, a change in the applied magnetic or electric field triggers a shift in the clustering phenomenon thus allowing precise and instantaneous electromagnetic or electrical circuit control (i.e., active control) of the onset of shear thickening and the resulting substantial increase in viscosity and shear stress. When the field and minimum shear are removed the viscosity of the fluid returns to its off-state level without the assistance of any force or condition. Such active control, of course, offers much greater response than passive shear thickening fluids.

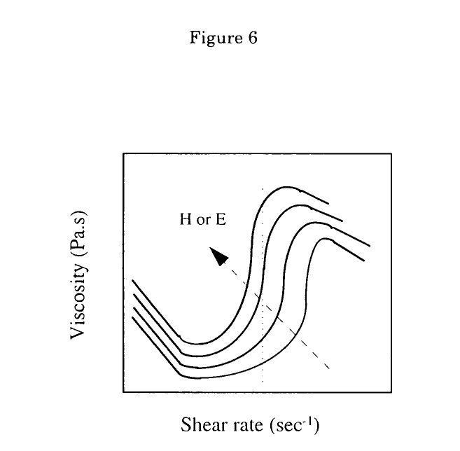

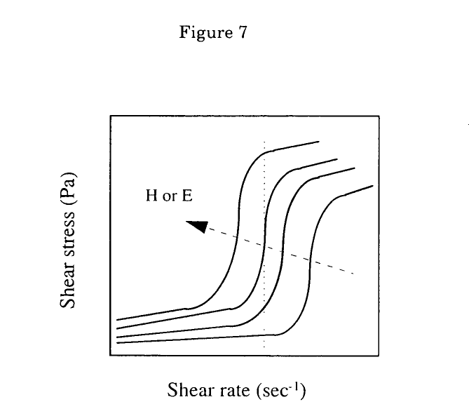

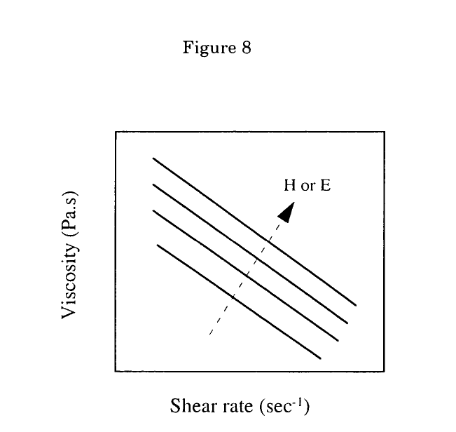

The shear thickening characteristic of the fluid in the present method and device is apparent from the graph of FIG. 7. FIG. 6 demonstrates that at a certain narrow shear rate the fluid undergoes a substantial increase in viscosity. Viewed another way, the increase in viscosity is non-linear over a longer period of increasing shear rate. A significant advantage of the invention is that the onset shear rate for increasing viscosity can be adjusted as desired by adjusting the level of the applied magnetic or electrical field. In addition, the amount or level of increase in viscosity from shear thickening also can be adjusted as desired by adjusting the level of the applied magnetic or electrical field. In general, the greater the applied field the lower the onset shear rate and the greater the increase in viscosity. In contrast, FIG. 8 demonstrates that the viscosity of a conventional magnetorheological or electrorheological fluid undergoes a relatively small substantially linear increase over a period of increasing shear rate.

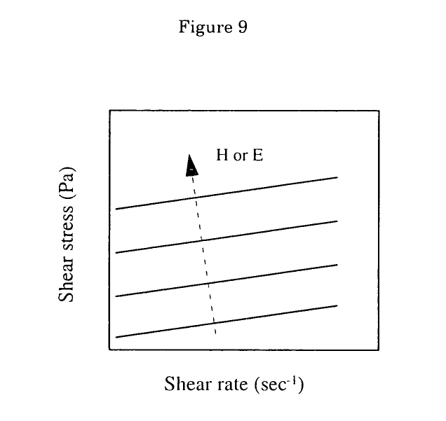

Similarly, FIG. 7 demonstrates that at a certain narrow shear rate the fluid undergoes a substantial increase in shear stress or yield stress. Viewed another way, the increase in shear or yield stress is non-linear over a longer period of increasing shear rate. A significant advantage of the invention is that the onset shear rate for increasing shear stress can be adjusted as desired by adjusting the level of the applied magnetic or electrical field. In addition, the amount or level of the increase in stress from shear thickening also can be adjusted as desired by adjusting the level of the applied magnetic or electrical field. In general, the greater the applied field the lower the onset shear rate and the greater the increase in stress. In contrast, FIG. 9 demonstrates that the shear stress of a conventional magnetorheological or electrorheological fluid undergoes a relatively small substantially linear increase over a period of increasing shear rate.

Of course, the viscosity and shear stress will also increase to a certain extent under the application of the field due to conventional magnetorheological or electrorheological phenomenon. In order to discount for this effect, the figures show the results assuming that the same given field is continuously applied over the range of increase in shear rate.

One advantage of the invention is the ability of the fluid to generate higher shear or yield stresses with applied fields that are relatively smaller than the fields used to generate the same level of stresses with conventional magnetorheological or electrorheological fluids. These higher stresses are derived from the additional stress generated by the shear thickening. Another advantage is that these fluids will respond to variations in deformation of the fluid as well as to the applied fields.

The magnetic-responsive particle component of the magnetic shear thickening fluid embodiment of the invention can be comprised of essentially any solid which is known to exhibit magnetorheological activity. Suitable magnetorheological fluids are described, for example, in U.S. Pat. No. 5,382,373 and published PCT International Patent Applications WO 94/10692, WO 94/10693 and WO 94/10694. The magnetic-responsive particles can range in size from 0.1 to 500 μm, with a size of 1 μm as being preferable. The volume percent of the magnetic-responsive particles in the present invention must be above about 40 percent by volume based on the total volume of the magnetorheological fluid.

U.S. Pat. No. 5,505,880 discloses suitable magnetorheological fluids that comprise coated magnetic particles having a particle size of less than 1 μm, a polar solvent and up to 20 percent by weight water. The solids content of the fluid according to the present invention should be in a range of from 40 to 80, preferably 50 to 60, volume percent.

U.S. Pat. No. 5,516,445 discloses a suitable fluid that includes electrically conductive magnetic particles that are coated with an electrically insulating layer and are dispersed in an electrically insulating solvent. The particle size of the magnetic particles can be from 0.003 to 200 μm and the amount of particles in the fluid should be at least 40 volume percent.

U.S. Pat. No. 5,525,249 discloses suitable magnetorheological fluids that include a mixture of magnetosoft particles said to have a particle size of 1 to 10 μm and magnetosolid particles said to have a particle size of 0.1 to 1.0 μm. The magnetosolid particles have a needle-like shape and their own magnetic moments so that they adsorb to the magnetosoft particles.

U.S. Pat. No. 5,143,637 discloses a suitable ferrofluid that includes ferromagnetic particles and a carrier fluid. The content of ferromagnetic particles may from 40 vol % to 70 vol %.

Typical magnetic-responsive particle components useful in the present invention are comprised of, for example, paramagnetic, superparamagnetic or ferromagnetic compounds. Superparamagnetic compounds are especially preferred. Specific examples of magnetic-responsive particle components include particles comprised of materials such as iron, iron oxide, iron nitride, iron carbide, carbonyl iron, chromium dioxide, low carbon steel, silicon steel, nickel, cobalt, and mixtures thereof. The iron oxide includes all known pure iron oxides, such as Fe₂O₃ and Fe₃O₄, as well as those containing small amounts of other elements, such as manganese, zinc or barium. Specific examples of iron oxide include ferrites and magnetites. In addition, the magnetic-responsive particle component can be comprised of any of the known alloys of iron, such as those containing aluminum, silicon, cobalt, nickel, vanadium, molybdenum, chromium, tungsten, manganese and/or copper.

The magnetic-responsive particle component can also be comprised of the specific iron-cobalt and iron-nickel alloys described in U.S. Pat. No. 5,382,373. The iron-cobalt alloys useful in the invention have an iron:cobalt ratio ranging from about 30:70 to 95:5, preferably ranging from about 50:50 to 85:15, while the iron-nickel alloys have an iron:nickel ratio ranging from about 90:10 to 99:1, preferably ranging from about 94:6 to 97:3. The iron alloys may contain a small amount of other elements, such as vanadium, chromium, etc., in order to improve the ductility and mechanical properties of the alloys. These other elements are typically present in an amount that is less than about 3.0% by weight. Due to their ability to generate somewhat higher yield stresses, the iron-cobalt alloys are presently preferred over the iron-nickel alloys for utilization as the particle component in a magnetorheological material. Examples of the preferred iron-cobalt alloys can be commercially obtained under the tradenames HYPERCO (Carpenter Technology), HYPERM (F. Krupp Widiafabrik), SUPERMENDUR (Arnold Eng.) and 2V-PERMENDUR (Western Electric).

The magnetic-responsive particle component of the invention is typically in the form of a metal powder which can be prepared by processes well known to those skilled in the art. Typical methods for the preparation of metal powders include the reduction of metal oxides, grinding or attrition, electrolytic deposition, metal carbonyl decomposition, rapid solidification, or smelt processing. Various metal powders that are commercially available include straight iron powders, reduced iron powders, insulated reduced iron powders, cobalt powders, and various alloy powders such as [48%]Fe/[50%]Co/[2%]V powder available from UltraFine Powder Technologies.

The preferred magnetic-responsive particles are those that contain a majority amount of iron in some form and are multidomain (i.e., the exhibit substantially no inherent or residual magnetism). Carbonyl iron powders that are high purity iron particles made by the thermal decomposition of iron pentacarbonyl are particularly preferred. Carbonyl iron of the preferred form is commercially available from ISP Technologies, GAF Corporation and BASF Corporation. The preferred particles are not coated with a layer of another material except for any oxides that might inherently form on the surface of the particles when the particles are exposed to ambient atmospheric conditions.

The magnetic-responsive particles should have a preferred average particle size distribution of 300 nm to 800 nm. Conventional magnetorheological fluids typically have an average particle size of greater than 1 micron. Particle sizes on the micron level will not provide a fluid that exhibits shear thickening because thermal (Brownian) forces are required to return the clustered particles to their unclustered state. Smaller particle sizes can possibly be used; however, the thermal forces may prevent the clustering altogether, thereby eliminating the shear thickening effect

Another important feature of the invention is the amount of the magnetic-responsive particles in the shear thickening fluid. The amount or particles should be greater than 40 percent by volume, based on the total volume of the shear thickening fluid. Preferably the amount is form 50 to 65% by volume. If the volume percentage of magnetic-responsive particles is lower than the minimum, the fluid will exhibit inadequate viscosity change above the critical shear thickening rate. The amount of magnetic-responsive particles can range up to any amount that still provides a workable fluid, but in most circumstances the amount probably will not exceed 65 volume percent.

The carrier component of the magnetic embodiment is a fluid that forms the continuous phase of the magnetic shear thickening fluid. Suitable carrier fluids may be found to exist in any of the classes of liquids known to be carrier fluids for magnetorheological fluids such as natural fatty oils, mineral oils, polyphenylethers, dibasic acid esters, neopentylpolyol esters, phosphate esters, polyesters (such as perfluorinated polyesters), synthetic cycloparaffins and synthetic paraffins, unsaturated hydrocarbon oils, monobasic acid esters, glycol esters and ethers, synthetic hydrocarbon oils, perfluorinated polyethers, silicone oils and halogenated hydrocarbons, as well as mixtures and derivatives thereof. The carrier component may be a mixture of any of these classes of fluids. The preferred carrier component is non-volatile, non-polar and does not include any significant amount of water. The carrier component (and thus the magnetic shear thickening fluid) particularly preferably should not include any volatile solvents commonly used in lacquers or compositions that are coated onto a surface and then dried such as toluene, cyclohexanone, methyl ethyl ketone, methyl isobutyl ketone and acetone. Descriptions of suitable carrier fluids can be found, for example, in U.S. Pat. No. 2,751,352 and U.S. Pat. No. 5,382,373, both hereby incorporated by reference. Non-polar hydrocarbons, such as mineral oils, paraffins, cycloparaffins (also known as naphthenic oils) and synthetic hydrocarbons are the preferred classes of carrier fluids. The synthetic hydrocarbon oils include those oils derived from oligomerization of olefins such as polybutenes and oils derived from high alpha olefins of from 8 to 20 carbon atoms by acid catalyzed dimerization and by oligomerization using trialuminum alkyls as catalysts. Poly-α-olefin is a particularly preferred carrier fluid.

Carrier fluids appropriate to the present invention may be prepared by methods well known in the art and many are commercially available. The carrier fluid is typically utilized in a minimum amount ranging from 30 to 60 vol %, preferably 45 to 55 percent by volume of the total magnetic shear thickening fluid.

The ER or MR responsive fluid can be readily designed for obtaining a desired predetermined critical shear stress for triggering the onset of shear thickening. The critical shear stress for a fluid can be determined for shear flow and bulk flow as a function of the solvent, particle size, particle shape, particle concentration, and interparticle interactions. Shear thickening occurs for neutral or charged particles either through electrostatic, entropic or steric interaction. The critical shear rate for the onset of shear thickening is reached at the maximum packing fraction for monodisperse systems typically at a volume percent of from 50 to 60% for the dispersed phase. See, Bender, J. and Wagner, N., Reversible Shear thickening in Monodisperse and Bidisperse Colliodal Dispersions, J. Rheology 40(5), September-October 1996, pp. 899-916.

The magnetic shear thickening fluid can optionally include other additives such as a thixotropic agent, a carboxylate soap, an antioxidant, a lubricant and a viscosity modifier. If present, the amount of these optional additives typically ranges from about 0.25 to about 10, preferably about 0.5 to about 7.5, volume percent based on the total volume of the magnetic shear thickening fluid.

Useful thixotropic agents are described, for example, in WO 94/10693 and commonly-assigned U.S. patent application Ser. No. 08/575,240, incorporated herein by reference. Such thixotropic agents include polymer-modified metal oxides. The polymer-modified metal oxide can be prepared by reacting a metal oxide powder with a polymeric compound that is compatible with the carrier fluid and capable of shielding substantially all of the hydrogen-bonding sites or groups on the surface of the metal oxide from any interaction with other molecules. Illustrative metal oxide powders include precipitated silica gel, fumed or pyrogenic silica, silica gel, titanium dioxide, and iron oxides such as ferrites or magnetites. Examples of polymeric compounds useful in forming the polymer-modified metal oxides include siloxane oligomers, mineral oils and paraffin oils, with siloxane oligomers being preferred. The metal oxide powder may be surface-treated with the polymeric compound through techniques well known to those skilled in the art of surface chemistry. A polymer-modified metal oxide, in the form of fumed silica treated with a siloxane oligomer, can be commercially obtained under the trade names AEROSIL R-202 and CABOSIL TS-720 from DeGussa Corporation and Cabot Corporation, respectively.

Examples of carboxylate soaps include lithium stearate, calcium stearate, aluminum stearate, ferrous oleate, ferrous naphthenate, zinc stearate, sodium stearate, strontium stearate and mixtures thereof.

The electrical-responsive particle component of the electrical shear thickening fluid embodiment of the invention can be comprised of essentially any solid which is known to exhibit electrorheological activity. Specific examples of electrical-responsive particle components include particles comprised of materials such as atomically polarizable particles of titanium dioxide, lithium niobate, sodium chloride, potassium dihydrogen phosphate, lead magnesium niobate, barium titanate, strontium titanate, lead titanate, and lead zirconate titanate as described in U.S. Pat. No. 5,294,360; a conjugated dye or pigment that contains an ionic charge as described in U.S. Pat. No. 5,306,438; carboxylic acid salts, aryl and alkyl aryl sulfonates, alkyl sulfates, and other anionic surfactants as described in U.S. Pat. No. 5,032,307; aluminum silicate; silica gel; and alumina.

According to the invention the increase in viscosity does not depend on a strong polarizability of the particles, fluid or solid colliodally dispersed polymers are suitable as the electrical-responsive particle component. One suitable class includes oil-insoluble polymers such as polysaccharides, polyvinylacetate or polyvinylalcohol or a copolymer of the same, polyacrylic acid, or polyacrylic ester dispersed in a polar carrier fluid or in an oil carrier fluid that includes conventional surfactants. Another suitable class includes oil-dispersible polymers such as polyalkylmethacrylates, polystyrene, polyvinyl chloride, polytetraflouroethylene, styrene-butadiene copolymer, styrene-acrylonitrile copolymer dispersed in a non-polar carrier fluid.

An important feature of the invention is the size of the electrical-responsive particles. The particles should have an average particle size distribution of 300 nm to 800 nm. Particle sizes on the micron level will not provide a fluid that exhibits shear thickening because thermal (Brownian) forces are required to return the clustered particles to their unclustered state. Smaller particle sizes can possibly be used; however, the thermal forces may prevent the clustering altogether, thereby eliminating the shear thickening effect.

Another important feature of the invention is the amount of the electrical-responsive particles in the shear thickening fluid. The amount should be greater than 50 percent by volume, based on the total volume of the shear thickening fluid. If the volume percentage of electrical-responsive particles is lower, the fluid will exhibit commensurately lower degrees of shear thickening because the degree of clustering is not as pronounced at lower volume fractions. The amount of electrical-responsive particles can range up to any amount that still provides a workable fluid, but in most circumstances the amount probably will not exceed 65 volume percent.

The carrier component of the electrical embodiment is a fluid that forms the continuous phase of the electrical shear thickening fluid. It may be selected from any of a large number of electrically insulating, hydrophobic liquids known for use in electrorheological fluids as described, for example, in U.S. Pat. No. 5,032,307. Typical liquids include mineral oils, white oils, paraffin oils, chlorinated hydrocarbons such as 1-chlorotetradecane, silicone oils, transformer oils, halogenated aromatic liquids, halogenated paraffins, polyoxyalkylenes, fluorinated hydrocarbons and mixtures thereof. Silicone oils having viscosities of between about 0.65 and 1000 mPa·s are the preferred carrier fluids for the electrical embodiment.

The carrier fluid is typically utilized in an amount ranging from less than 50, preferably to 35 percent by volume of the total electrical shear thickening fluid.

The electrical filed responsive fluids can include additives such as activators known for use in electrorheological fluids. Typical activators include water, methyl, ethyl, propyl, isopropyl, butyl and hexyl alcohols; ethylene glycol, diethylene glycol, propylene glycol, glycerol; formic, acetic and lactic acids; aliphatic, aromatic and heterocyclic amines.

The particle component and carrier component can be mixed together by procedures well known in the art.

The shear thickening fluid of the invention can be used in any active controllable device such as dampers, mounts, clutches, brakes, valves and similar devices. These devices include a housing or chamber that contains the shear thickening fluid. The shearing force to which the fluid is subjected can be generated, for example, by a piston or a rotor in such devices. The fluid can be initially subjected to only the shearing force and then after a certain time also be subjected to the field. Such devices are known and are described, for example, in U.S. Pat. No. 5,277,281; U.S. Pat. No. 5,284,330; U.S. Pat. No. 5,398,917; U.S. Pat. Nos. 5,492,312; 5,176,368; 5,257,681; 5,353,839; and 5,460,585, all incorporated herein by reference.

A damper, more fully described in U.S. Pat. No. 5,277,281 which is suitable in the present invention is an apparatus for variably damping motion. The apparatus employs a magnetorheological fluid. The damper comprises:
a) a housing for containing a volume of magnetorheological fluid;
b) a piston adapted for movement within the fluid-containing housing, the piston being comprised of a ferrous metal. The device incorporates a number of windings of an electrically conductive wire defining a coil which produces magnetic flux in and around the piston. The device is preferably configured according to an equation where the following are predetermined:
c) a minimum lateral cross-sectional area of said piston within the coil,
d) a minimum lateral cross-sectional area of magnetically permeable material defining a return path for the magnetic flux,
e) a surface area of a magnetic pole of the piston,
f) an optimum magnetic flux density for the magnetorheological fluid,
g) a magnetic flux density at which a magnetic responsive metal begins to become saturated; and
h) a valve means associated with one of the housing and piston for controlling movement of said magnetorheological fluid.

Another suitable device, more fully described in U.S. Pat. No. 5,398,917 is a magnetorheological fluid mount for damping vibration between a first member generating vibrating energy and a second supporting member. The fluid mount comprises:
a) a housing attachable to one of the first and second members;
b) an attachment collar attachable to another one of the members;
c) an elastomeric element bonded to the housing and to the attachment collar and at least partially forming a first fluid chamber, the first fluid chamber containing a magnetorheological fluid;
d) an elastomeric bladder element at least partially forming a second fluid chamber containing magnetorheological fluid;
e) an intermediate passageway interconnecting said first and second fluid chambers, said intermediate passageway extending generally axially through a laterally extending baffle-plate housing and permitting significant amounts of magneto-rheological fluid to flow between said first and second fluid chambers and being equipped with valve means;
f) a magnetic coil forming part of said valve means being contained within and extending about a peripheral portion of said baffle-plate housing and controlling the flow of said magnetorheological fluid through said passageway; and
g) a means to increase contact of said magnetorheological fluid with said magnetic coil to enhance flow control including a baffle plate stationarily mounted within said baffle-plate housing extending laterally across said intermediate passageway thereby forcing said magnetorheological fluid to flow outwardly toward said magnetic coil.

### EXAMPLE 1

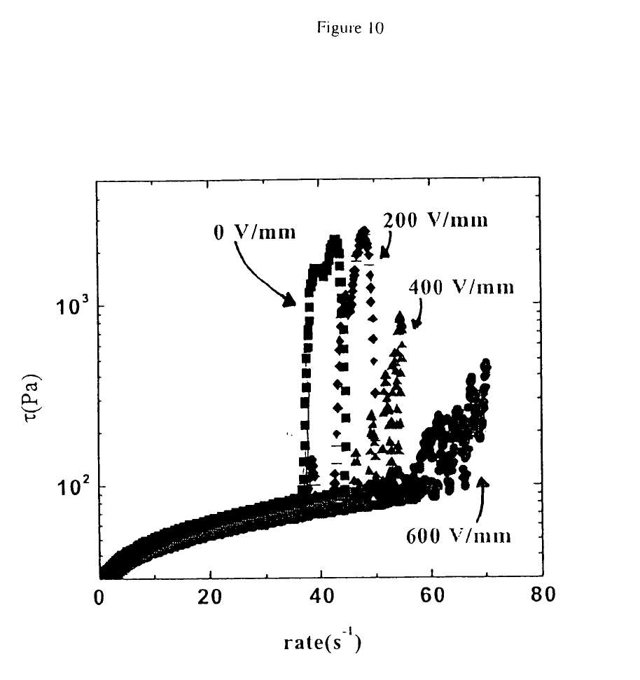

A silica dispersion comprising 66 weight percent solliodal silica in methylcyclohexanol was placed in strain controlled cone and plate rheometer (RMS, Rheometrics Scientific, Inc.); using 50 mm diameter parallel plates at a 0.5 mm gap. Calibration of the rheometer was performed to validate parallelism. ER experiments were conducted at 25 C. Samples were loaded and pre-sheared at 0.1 s⁻¹ for 120 seconds to equalize shear history prior to measurements. Ramp tests at 1-1000 s⁻¹ in 90 sec.) were performed ascending and descending in sequence. Measurements were reproducible within instrument resolution with applied potentials using a Good Will Instruments generator GFG 8016G, Trek amplifier model 609E-6 were zero mean square wave AC voltages. With reference to FIG. 10, it can be seen that the onset of shear thickening is controlled by changes in the electric field strength. With zero field applied, critical shear rate for this fluid occurred at the frequency of 40 s⁻¹, and was increased successively by the application of field strengths at 200, 400, and 600 V/mm.

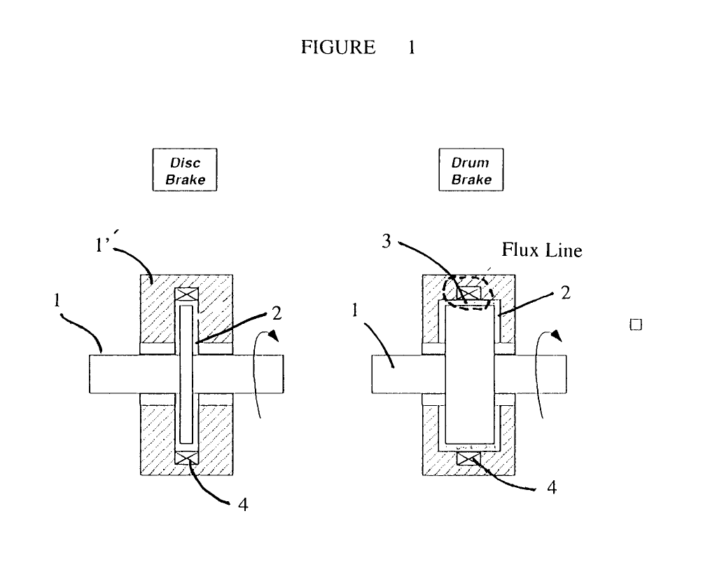

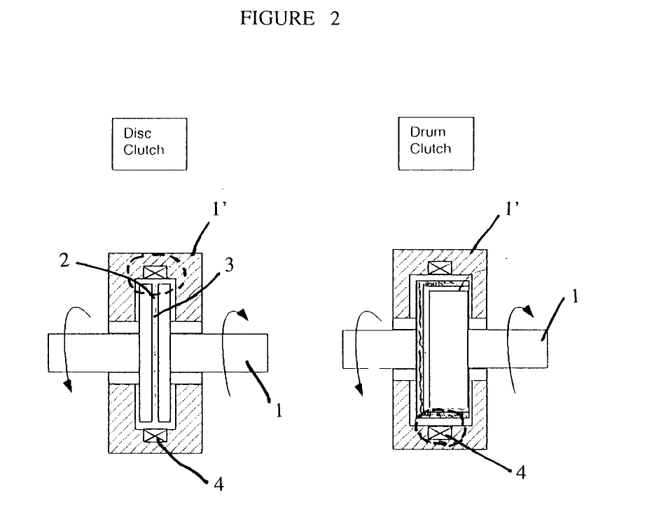

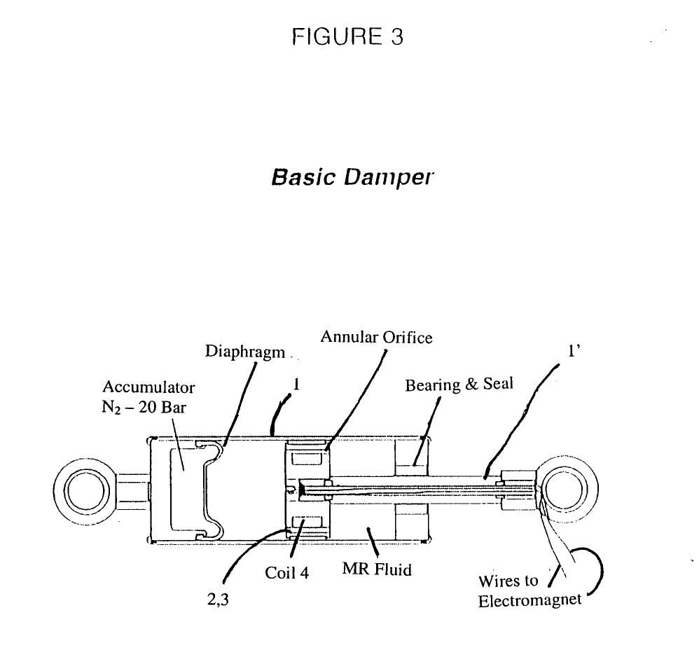

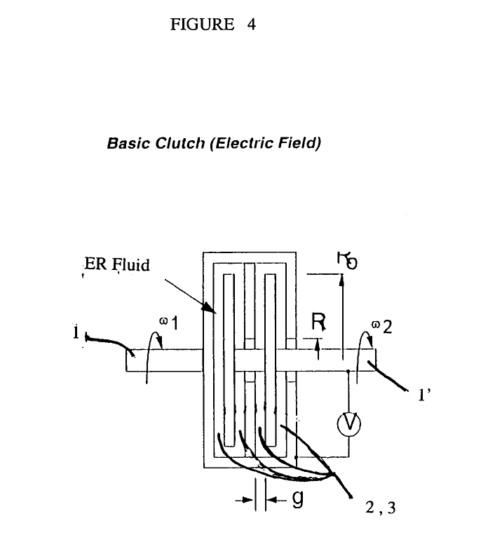

With reference to FIGS. 1-4, wherein like references depict like components, there are depicted first and second members at 1 and 1′, a gap 2, a field responsive fluid 3, and means of applying a field to the fluid within the gap at 4.

1-47. (canceled)

48. A method for controlling motion comprising applying an electrical or magnetic field to a confined field-responsive fluid under shearing or displacement force, said fluid operative at the interface between a drive member and a driven member, changing the motion of said driven member by shifting the critical shear rate of said field-responsive fluid in response to a change in field intensity.

49. The method according to claim 48 wherein the particles have an average particle size of 300 nm to 800 nm.

50. The method according to claim 48 wherein the particles are electrical-responsive particles comprising a material selected from the group consisting of titanium dioxide, lithium niobate, sodium chloride, potassium dihydrogen phosphate, lead magnesium niobate, barium titanate, strontium titanate, lead titanate, lead zirconate titanate, a conjugated dye or pigment that includes an ionic charge, carboxylic acid salts, aryl and alkyl aryl sulfonates, alkyl sulfates, aluminum silicate, silica gel, alumina, silicon dioxide (glass), polysaccharide, polyvinyl acetate, polyvinylidene fluoride, polyvinyl alcohol, polyacrylic acid, polyacrylic ester, polyalkylmethacrylate, polystyrene, polyvinyl chloride, polytetrafluoroethylene, styrene-butadiene copolymer and styrene-acrylonitrile copolymer.

51. The method according to claim 48 wherein the particles are magnetic-responsive particles comprising a material selected from the group consisting of iron, iron oxide, iron nitride, iron carbide, carbonyl iron, chromium dioxide, low carbon steel, silicon steel, nickel and cobalt.

52. The method according to claim 48 wherein the magnetic-responsive particles comprise a magnetic-responsive material coated with a nonmagnetic-responsive material.

53. A method for increasing the shear stress of a field responsive fluid comprising (a) mixing magnetic- or electrical-responsive particles having an average particle size distribution of 100 nm to 3000 nm with carrier fluid component so that the resulting field responsive fluid includes more than 50 percent by volume, based on the total volume of the fluid, of the particles and (b) subjecting the field responsive fluid to a shearing force and a magnetic or electrical field.

54. The method according to claim 53 wherein the particles have an average particle size of 300 nm to 800 nm.

55. The method according to claim 53 wherein the particles are electrical-responsive particles comprising a material selected from the group consisting of titanium dioxide, lithium niobate, sodium chloride, potassium dihydrogen phosphate, lead magnesium niobate, barium titanate, strontium titanate, lead titanate, lead zirconate titanate, a conjugated dye or pigment that includes an ionic charge, carboxylic acid salts, aryl and alkyl aryl sulfonates, alkyl sulfates, aluminum silicate, silica gel, alumina, silicon dioxide (glass), polysaccharide, polyvinyl acetate, polyvinylidene fluoride, polyvinyl alcohol, polyacrylic acid, polyacrylic ester, polyalkylmethacrylate, polystyrene, polyvinyl chloride, polytetrafluoroethylene, styrene-butadiene copolymer and styrene-acrylonitrile copolymer.

56. A method according to claim 53 wherein the particles are magnetic-responsive particles comprising a material selected from the group consisting of iron, iron oxide, iron nitride, iron carbide, carbonyl iron, chromium dioxide, low carbon steel, silicon steel, nickel and cobalt.

57. A method according to claim 53 wherein the magnetic-responsive particles comprise a magnetic-responsive material coated with a nonmagnetic-responsive material.

58. A method for reducing the viscosity and suppressing the onset shear rate of a shear thickening fluid comprising mixing electrical- or magnetic-responsive particles into the fluid and subjecting the fluid to an electrical or magnetic field.

59. The method according to claim 58 wherein the fluid includes more than 50 volume percent particles based on the total volume of the fluid.

60. The method according to claim 58 wherein the particles have an average particle size of 300 nm to 800 nm.

61. A method according to claim 58 wherein the particles are electrical-responsive particles comprising a material selected from the group consisting of titanium dioxide, lithium niobate, sodium chloride, potassium dihydrogen phosphate, lead magnesium niobate, barium titanate, strontium titanate, lead titanate, lead zirconate titanate, a conjugated dye or pigment that includes an ionic charge, carboxylic acid salts, aryl and alkyl aryl sulfonates, alkyl sulfates, aluminum silicate, silica gel, alumina, silicon dioxide (glass), polysaccharide, polyvinyl acetate, polyvinylidene fluoride, polyvinyl alcohol, polyacrylic acid, polyacrylic ester, polyalkylmethacrylate, polystyrene, polyvinyl chloride, polytetrafluoroethylene, styrene-butadiene copolymer and styrene-acrylonitrile copolymer.

62. The method according to claim 58 wherein the particles are magnetic-responsive particles comprising a material selected from the group consisting of iron, iron oxide, iron nitride, iron carbide, carbonyl iron, chromium dioxide, low carbon steel, silicon steel, nickel and cobalt.

63. The method according to claim 58 wherein the magnetic-responsive particles comprise a magnetic-responsive material coated with a nonmagnetic-responsive material.
